(19) United States
(12) Patent Application Publication
(10) Pub. No.: US 2025/0298246 A1
(43) Pub. Date: Sep. 25, 2025

(54) MICRO-GALVANOMETER AND OPTICAL DEVICE

(71) Applicant: TRIPLE WIN TECHNOLOGY(SHENZHEN) CO.LTD., Shenzhen (CN)

(72) Inventor: HSIANG-CHIEH YU, NewTaipei (TW)

(21) Appl. No.: 18/772,323

(22) Filed: Jul. 15, 2024

(30) Foreign Application Priority Data
Mar. 20, 2024 (CN) 202410322130.0

(51) Int. Cl. G02B 27/01

(52) U.S. Cl. CPC G02B 27/0172; G02B 2027/0178

(57) ABSTRACT

A micro-galvanometer includes a reflecting part, at least two supporting parts surrounding the reflecting part, and a fixing part surrounding the at least two supporting parts. The reflecting part includes a substrate and a metasurface layer on the substrate. The metasurface layer includes a substrate layer and a plurality of nanopillars on the substrate layer. The metasurface layer is configured to receive and reflect first light. The nanopillars are configured to reflect a portion of the first light to emit sub-reflected light. Each supporting part includes a first end and a second end opposite to the first end. The first end is movably connected to the reflecting part. The fixing part is connected to the second end. The reflecting part can swing/rotate relative to the fixing part.

### FIELD

The subject matter herein relates to a field of near-eye display, particularly to a micro-galvanometer and an optical device having the micro-galvanometer.

### BACKGROUND

Augmented Reality (AR) head mounted optical display system based on laser beam scanning (LBS) has advantages of high brightness, small size, and low power consumption. However, for the AR head mounted optical display systems based on LBS, outgoing light received by human eyes is formed by superposition of continuous reflection of image light by multiple lenses. Due to the interference phenomenon between the image light (hereinafter referred to as first light) and reflected light, the image formed by the reflected light will have periodic granular stray light spots. These stray light spots can reduce image resolution, contrast, and display uniformity, leading to discomfort for the human eyes. The conventional technology suppresses granular light spots by adding high-frequency modulation driving signals or stacking multiple light sources to reduce coherence of the laser by time and space. However, the conventional technology has problems such as large volume, high complexity, and poor stability.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of a micro-galvanometer according to an embodiment of the present disclosure.

FIG. 2 is an enlarged view of a portion labeled II in FIG. 1.

FIG. 3 is an enlarged view of a metasurface layer according to another embodiment of the present disclosure.

FIG. 4 is a schematic view of a light source of an optical device according to an embodiment of the present disclosure.

FIG. 5 is a schematic view of an optical device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

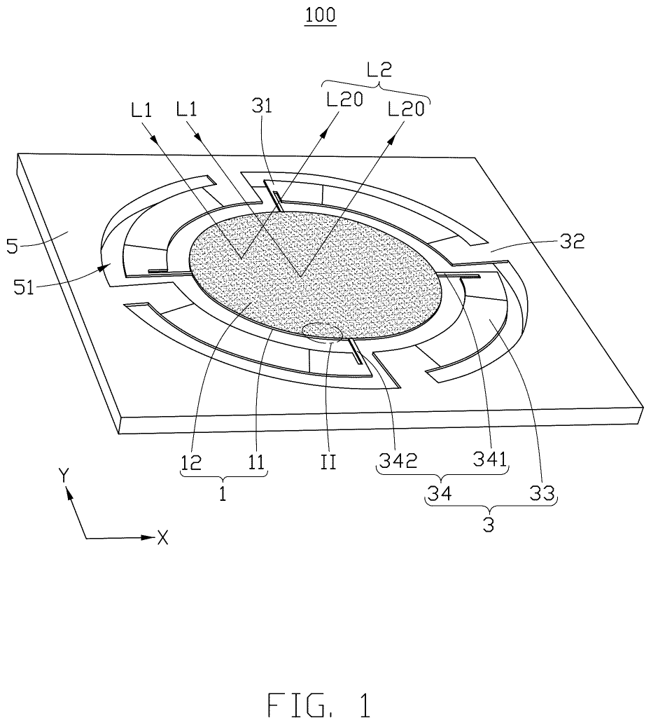

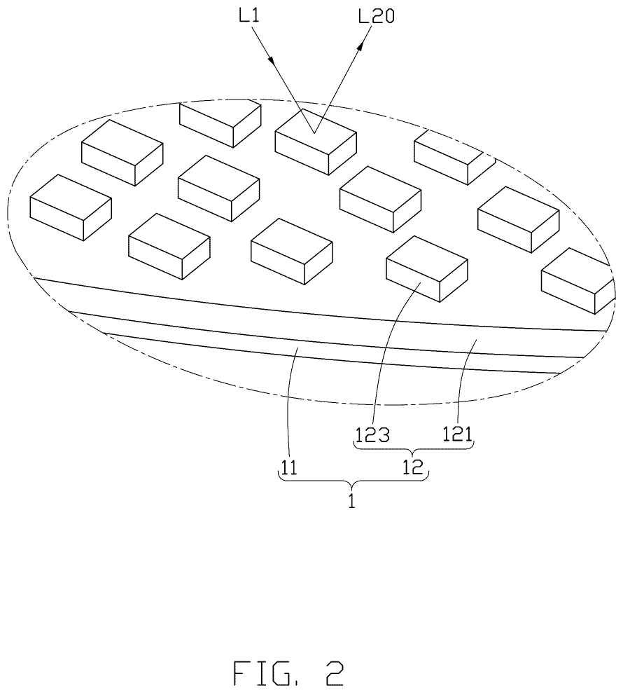

As shown in FIG. 1 and FIG. 2, a micro-galvanometer 100 of the present embodiment includes a reflecting part 1, at least two supporting parts 3, and a fixing part 5. The at least two supporting parts 3 surround the reflecting part 1. The fixing part 5 surrounds the at least two supporting parts 3. The reflecting part 1 includes a substrate 11 and a metasurface layer 12 stacked on a side of the substrate 11. The metasurface layer 12 includes a substrate layer 121 stacked on the substrate 11 and a plurality of nanopillars 123 on a surface of the substrate layer 121 away from the substrate 11. The metasurface layer 12 is used to receive and reflect first light L1, and the nanopillars 123 reflect a portion of the first light L1 to emit sub-reflected light L20. Multiple beams of the sub-reflected light L20 are combined into reflected light L2. The reflected light L2 includes the sub-reflected light L20 having multiple different phases. Each supporting part 3 includes a first end 31 and a second end 32 opposite to the first end 31. The first end 31 is movably connected to the reflecting part 1. The supporting part 3 is used to change emitting direction of the reflected light L2. The second end 32 of the supporting part 3 is connected to the fixing part 5, and the reflecting part 1 can swing/rotate relative to the fixing part 5 by the supporting part 3.

For the micro-galvanometer 100 provided in the present embodiment, the reflecting part 1 is driven by the supporting part 3 to swing/rotate relative to the fixing part 5, thereby driving the metasurface layer 12 to swing/rotate. When the first light L1 incidents on the micro-galvanometer 100, the nanopillars 123 of the metasurface layer 12 reflect a portion of the first light L1 to emit the sub-reflected light L20, and the sub-reflected light L20 with different phases is synthesized into the reflected light L2, thereby reducing periodic stray light spots generated by the coherence between the first light L1 and the reflected light L2, and effectively suppressing the speckle of the reflected light L2. When the micro-galvanometer 100 is applied to a head mounted display device, it is beneficial to reduce a volume of the head mounted display device, reduce the speckle of the image displayed by the head mounted display device, improve display effect, and thus reduce eye discomfort.

In this embodiment, the substrate layer 121 of the metasurface layer 12 is made of silicon. Using silicon as the material of the substrate layer 121 has advantages of high stability and low cost. As the material of the substrate layer 121 depends on an application environment of the micro-galvanometer 100, in other embodiments, the substrate layer 121 can also be made of other material, such as, but not limited to, quartz, indium phosphide, or silicon nitride, or a mixture thereof.

The nanopillars 123 can be made of a metal material having high reflectivity. For example, at least one metal such as gold (Au), silver (Ag), copper (Cu), aluminum (Al), iron (Fe), or platinum (Pt), or an alloy including at least one of the aforementioned metals. In addition, the nanopillar 123 can also be made of piezoelectric materials, such as quartz crystals, lithium galliate, lithium germanate, titanium germanate, iron transistor lithium niobate, and lithium tantalate, etc. The material of nanopillar 123 can be any one of metal, piezoelectric material or electro-optic materials.

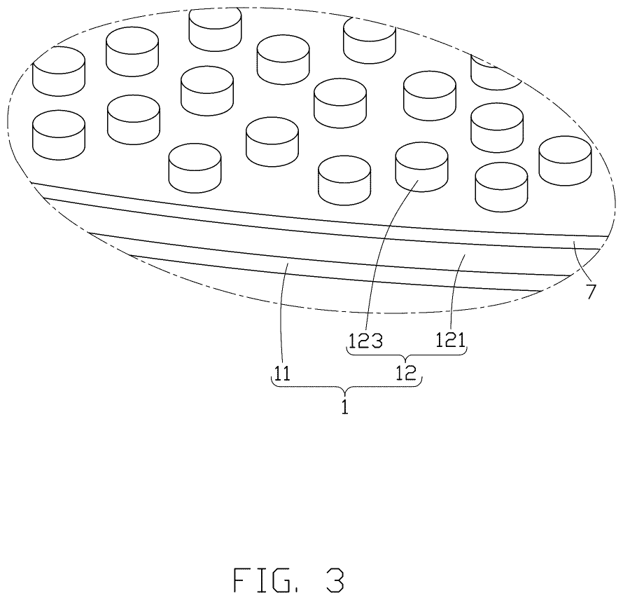

For example, in an embodiment, the nanopillar 123 is made of quartz crystal. In order to meet the high reflectivity requirements of the micro-galvanometer 100, as shown in FIG. 3, the micro-galvanometer 100 further includes a high reflectivity film 7. The high reflectivity film 7 is on a side of the metasurface layer 12 to receive and reflect the first light L1, and the high reflectivity film 7 is used to enhance reflection of the metasurface layer 12 for the first light L1. The high reflectivity film 7 can be made of a metal or compound, such as gold, silver, platinum, aluminum, copper, magnesium fluoride, silicon monoxide, silicon dioxide, aluminum oxide, etc., as long as it has high reflectivity for some of the first light L1, it is within the protection scope of this disclosure.

In this embodiment, the substrate layer 121 and the metasurface layer 12 are integrally formed, and a silicon plate can be deeply etched at low temperature using various etching mask to form a metasurface layer 12 having the nanopillars 123. Then, the metasurface layer 12 is bonded to a side of the substrate 11 using an adhesive, and the metasurface layer 12 fully covers a surface of the substrate 11. In other embodiments, nanopillars 123 can also be bonded to the substrate layer 121 by using an adhesive, and then the metasurface layer 12 can be bonded to a side of the substrate 11 using the adhesive. An area size of the metasurface layer 12 can also be less than an area size of the substrate 11, depending on usage conditions of the micro-galvanometer 100. The metasurface layer 12 partially covers the surface of the substrate 11.

As shown in FIG. 2, in this embodiment, the nanopillars 123 are metal cubes having a same size and a high reflectivity. Any edge length of the cube structure of the nanopillar 123 is less than a wavelength of the first light L1. For example, when the wavelength of the first light L1 is 850 nm, a maximum edge length of the nanopillar 123 is less than 850 nm. The nanopillars 123 are irregularly distributed on the substrate layer 121. That is, the nanopillars 123 are randomly arranged on the substrate layer 121. As shown in FIG. 3, in other embodiments, the nanopillars 123 can also be irregularly arranged cylindrical structure. The shape of nanopillar 123 can be any one of spherical, cubic, cylindrical, or toroidal. The shape, size, and arrangement of the nanopillars 123 depend on the application environment of the micro-galvanometer 100. A maximum diameter of the nanopillar 123 can be less than the wavelength of the first light L1. In addition, the size and shape of the nanopillars 123 of the metasurface layer 12 may be different from each other, or the size/shape of the nanopillars 123 may be different from each other, and this disclosure is not limited.

The metasurface layer 12 composed of a substrate layer 121 and the nanopillars 123 is used as a random phase plate having specific random phase function. The reflecting part 1 with the metasurface layer 12 is movably supported by at least two supporting parts 3. When the reflecting part 1 swings/rotates relative to the fixing part 5, the emitting direction of the reflected light L2 can be changed. When the first light L1 with coherence passes through the metasurface layer 12, the phase of the reflected light L2 has been scattered and randomly distributed. When the supporting part 3 drives the reflecting part 1 to swing periodically relative to the fixing part 5, the speckle pattern changes continuously with time and space. N speckle patterns will be obtained within one collection cycle, and the speckle contrast will correspondingly decrease to 1/\sqrt{n} of speckle contrast in original static state. When a number of incoherent independent speckle patterns N increases within one sampling cycle, the speckle contrast of the synthesized reflected light L2 will decrease, that is, the speckle phenomenon will be weakened.

Specifically, the reflecting part 1 is driven to swing/rotate relative to the fixing part 5 by any one of the methods of electrostatic drive, electromagnetic driving method, piezoelectric driving method, or thermoelectric driving method.

As shown in FIG. 1, in this embodiment, the reflecting part 1 is driven by a piezoelectric driving method to swing relative to the fixing part 5. The micro-galvanometer 100 includes four supporting parts 3. Each supporting part 3 includes a driving arm 33 and a connecting shaft 34 connecting to the driving arm 33. The driving arm 33 includes opposite ends, one end of the driving arm 33 is fixedly connected to the fixing part 5, the other end of the driving arm 33 is fixedly connected to the connecting shaft 34. An end of the connecting shaft 34 that is far away from the driving arm 33 is fixedly connected to the reflecting part 1. The fixing part 5 defines a containment hole 51. The supporting parts 3 are in the containment hole 51. The supporting part 3 extends into the containment hole 51 from the fixing part 5, thereby supporting the reflecting part 1 in the containment hole 51. The containment hole 51 is circular. The driving arm 33 extends into to be an arc from the fixing part 5 inside the containment hole 51. The connecting shaft 34 is formed by extending one end of the driving arm 33 away from the fixing part 5 towards a center of the containment hole 51. The driving arm 33 is made of silicon-based piezoelectric ceramic. When voltages are applied to opposite electrodes of the driving arm 33, a lateral stretching effect of the piezoelectric ceramic causes the driving arm 33 to bend, resulting in movement at one end of the driving arm 33 near the connecting shaft 34.

In order to better transmit the swing, a size of the connecting shaft 34 along a radial direction of the containment hole 51 is less than a size of the driving arm 33 along the radial direction of the containment hole 51. The connecting shaft 34 includes a first connecting shaft 341 extending along a first direction X and a second connecting shaft 342 extending along a second direction Y, where the first direction X intersects with the second direction Y and is in the same plane. In this embodiment, the first direction X is perpendicular to the second direction Y. In other embodiments, the first direction X may only intersect with the second direction Y, and this disclosure does not limit the first direction X to be perpendicular to the second direction Y. The connecting shaft 34 can be one or more. When the driving arm 33 shifts near one end of the connecting shaft 34, the first connecting shaft 341 (second connecting shaft 342) connected to the reflecting part 1 drives the substrate 11 to swing. When selecting a piezoelectric material having a great piezoelectric coefficient and conducting appropriate structural design, the substrate has a larger deflection angle at lower operating voltages. This disclosure does not limit the deflection angle range of the reflecting part 1. When the supporting part 3 drives the reflecting part 1 to swing periodically relative to the fixing part 5, the first connecting shaft 341/the second connecting shaft 342 can first drive the substrate 11 to swing at a certain angle, and then swing around the second connecting shaft 342/the first connecting shaft 341 at a certain angle. The specific situation depends on the usage requirements, and this disclosure is not limited.

In other embodiments, the reflecting part 1 is driven by an electromagnetic driving method to swing relative to the fixing part 5. The supporting part 3 is driven to twist using electromagnetic force. By an interaction between the current and the magnetic field generated by the magnetic material, an electromagnetic force generates and causes the reflecting part 1 to undergo torsional motion. In addition, the supporting part 3 can also use electrostatic driving to drive the reflecting part 1 to rotate. By the electrostatic attraction generated between charged conductors, the electrostatic attraction is applied to the reflecting part 1, and under the action of torque, the supporting part 3 undergoes torsional motion.

The micro-galvanometer 100 provided in the present embodiment, the reflecting part 1 is driven by the supporting part 3 to swing/rotate relative to the fixing part 5, thereby driving the metasurface layer 12 on the substrate 11 to rotate. When the first light L1 incidents on the micro-galvanometer 100, the nanopillars 123 of the metasurface layer 12 reflects a portion of the first light L1 to emit sub-reflection light L20, and the sub-reflection light L20 with different phases is synthesized into the reflected light L2, thereby reducing the periodic stray light spots generated by the coherence between the first light L1 and the reflected light L2, and effectively suppressing the speckle of the reflected light L2. When the micro-galvanometer 100 is applied to a head mounted display device, it is beneficial to reduce a volume of the head mounted display device, reduce the speckle of the image displayed by the head mounted display device, improve the display effect, and thus reduce eye discomfort.

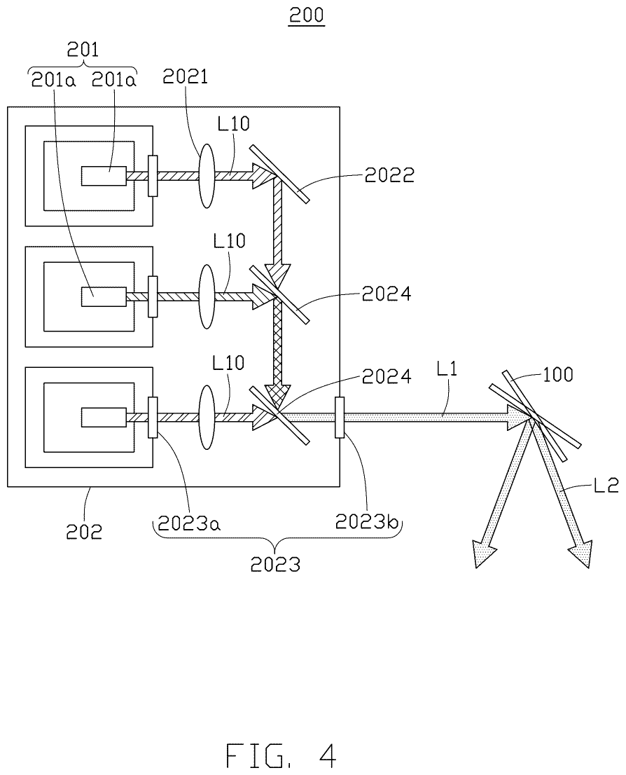

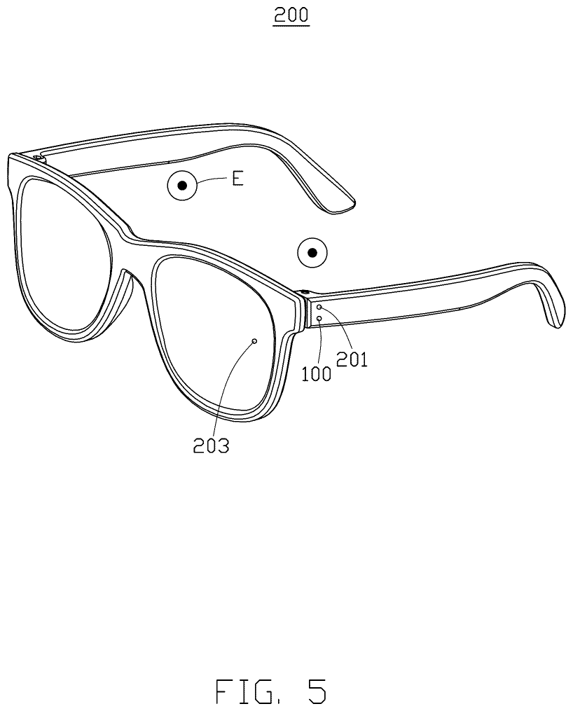

As shown in FIG. 4 and FIG. 5, the optical device 200 of the present embodiment includes a light source 201 and a micro-galvanometer 100 as described in any of the above embodiments. The light source 201 is used to emit the first light L1. The micro-galvanometer 100 is used to receive the first light L1 from the light source 201 and reflect the first light L1 to emit the reflected light L2. The light source 201 includes multiple sub-light sources 201a, each sub-light source 201a independently emits a beam of sub-first light L10, and multiple beams of the first light L10 forms the first light L1. The wavelength of the sub first light L10 emitted by the sub-light sources 201a may be the same or different, and the light source 201 may include one, two or more sub-light sources 201a, without limitation in this disclosure. For example, when the optical device 200 is a projection device, the light source 201 includes a red sub-light source, a green sub-light source, and a blue sub-light source. The red sub-light source emits red sub-first light, the green sub light source emits green sub-first light, and the blue sub light source emits blue sub-first light. The wavelength of the sub-first light L10 emitted by each sub-light source 201a is different.

When the optical device 200 is a head mounted display device, the optical device 200 further includes a beam combining device 202. The beam combining device 202 is used to synthesize the sub-first light L10 into the first light L1. The light source 201 is provided on an input side of the beam combining device 202, and the micro-galvanometer 100 is provided on an output side of the beam combining device 202. The beam combining device 202 includes a collimating mirror 2021, a reflecting mirror 2022, a window plate 2023, and a beam splitter 2024. The collimating mirror 2021 is used to focus each sub-first light L10. The beam splitter 2024 is used for transmitting a portion of the sub-first light L10 and reflecting a portion of the sub-first light L10. The reflecting mirror 2022 is used to receive a portion of sub-first light L10 emitted from the collimating mirror 2021, and to reflect the sub-first light L10 to the beam splitter 2024.

The window plate 2023 includes an input window plate 2023a and an output window plate 2023b. The window plate 2023 is used to separate environments on both sides, thereby protecting internal components. The input window plate 2023a is between the collimating mirror 2021 and the sub-light source 201a, and located on an output side of each sub-light source 201a. The output window plate 2023b is on an output side of the beam splitter 2024, and configured for receiving a portion of the sub-first light L10 emitted from the beam splitter 2024. In practical applications, the beam combining device 202 can be set according to actual needs, without being limited by the limitations in this embodiment. The micro-galvanometer 100 can change angles of light emission, dynamically adjust the angles of light emission, and also achieve dynamic adjustment of depth of field and focal length. The optical device 200 further includes an optical waveguide 203 for coupling the reflected light L2 emitted from the micro-galvanometer 100 into the human eye E.

In other embodiments, the optical device 200 can be a lidar, a hybrid reality head mounted display device, or a head up display device, without limitation in this disclosure. For example, when the optical device 200 is an optical ranging device, the optical ranging device can be applied in application fields such as radar, obstacle avoidance, 3D printing, image display, and free space optical communication.

The optical device 200 provided in the present embodiment, by setting the micro-galvanometer 100 described in any of the above embodiments, is conducive to reducing a volume of the optical device 200, effectively reducing periodic stray light spots generated by the coherence between the first light L1 and the reflected light L2, effectively suppressing the speckle of the reflected light L2, and improving the stability of the optical device 200. When the optical device 200 is a display device, it is beneficial to reduce speckle in the displayed image of the display device, improve the display effect, and thus reduce discomfort to the human eye.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A micro-galvanometer comprising:
a reflecting part comprising a substrate and a metasurface layer on a side of the substrate, the metasurface layer comprising a substrate layer and a plurality of nanopillars, the substrate layer being between the plurality of nanopillars and the substrate, the metasurface layer configured to receive and reflect first light, and the plurality of nanopillars configured to reflect a portion of the first light to emit sub-reflected light, beams of the sub-reflected light being combined to be reflected light comprising the sub-reflected light having different phases;
at least two supporting parts surrounding the reflecting part, each of the at least two supporting parts comprising a first end and a second end opposite to the first end, wherein the first end is movably connected to the reflecting part; and
a fixing part surrounding the at least two supporting parts, the fixing part connected to the second end of each of the at least two supporting parts, wherein the at least two supporting parts is configured to drive the reflecting part to swing/rotate relative to the fixing part.

2. The micro-galvanometer of claim 1, wherein the at least two supporting parts are further configured to drive the reflecting part to periodically oscillate relative to the fixing part.

3. The micro-galvanometer of claim 1, wherein the plurality of nanopillars is made of metal, piezoelectric material, or electro-optic material.

4. The micro-galvanometer of claim 1, wherein the plurality of nanopillars is randomly distributed on the substrate layer.

5. The micro-galvanometer of claim 1, wherein the plurality of nanopillars has different sizes and different shapes.

6. The micro-galvanometer of claim 1, wherein the fixing part defines a containment hole configured to receive the at least two supporting parts, the at least two supporting parts supports the reflecting part within the containment hole.

7. The micro-galvanometer of claim 1, wherein each of the at least two supporting parts comprises a connecting shaft and a driving arm connecting to the connecting shaft; one end of the driving arm is fixedly connected to the fixing part, and another end of the driving arms is fixedly connected to the connecting shaft; an end of the connecting shaft away from the driving arm is fixedly connected to the reflecting part.

8. The micro-galvanometer of claim 7, wherein the at least two supporting parts comprises a first connecting shaft extending along a first direction and a second connecting shaft extending along a second direction, the first direction intersects with the second direction.

9. The micro-galvanometer of claim 1, wherein the reflecting part is driven to swing/rotate relative to the fixing part by an electrostatic driving method, an electromagnetic driving method, a piezoelectric driving method, or a thermoelectric driving method.

10. An optical device comprising:
a light source configured to emit first light; and
a micro-galvanometer comprising:
a reflecting part, the reflecting part comprising a substrate and a metasurface layer on a side of the substrate, the metasurface layer comprising a substrate layer and a plurality of nanopillars, the substrate layer being between the plurality of nanopillars and the substrate, the metasurface layer configured to receive and reflect the first light from the light source, and the plurality of nanopillars configured to reflect a portion of the first light to emit sub-reflected light, beams of the sub-reflected light being combined to be reflected light comprising the sub-reflected light having different phases;
at least two supporting parts surrounding the reflecting part, each of the at least two supporting parts comprising a first end and a second end opposite to the first end, wherein the first end is movably connected to the reflecting part; and
a fixing part surrounding the at least two supporting parts, the fixing part connected to the second end of each of the at least two supporting parts, wherein the at least two supporting parts configured to drive the reflecting part to swing/rotate relative to the fixing part.

11. The optical device of claim 10, wherein the light source comprises a plurality of sub-light sources, each of the plurality of sub-light sources is configured to independently emit a beam of sub-first light, and beams of the first light form the first light.

12. The optical device of claim 10, wherein the at least two supporting parts are configured to drive the reflecting part to periodically oscillate relative to the fixing part.

13. The optical device of claim 10, wherein the plurality of nanopillars is made of metal, piezoelectric material, or electro-optic material.

14. The optical device of claim 10, wherein the plurality of nanopillars is randomly irregularly distributed on the substrate layer.

15. The optical device of claim 10, wherein the plurality of nanopillars has different sizes and different shapes.

16. The optical device of claim 10, wherein the fixing part defines a containment hole configured to receive the at least two supporting parts, the at least two supporting parts supports the reflecting part within the containment hole.

17. The optical device of claim 10, wherein each of the at least two supporting parts comprises a connecting shaft and a driving arm connecting to the connecting shaft; one end of the driving arm is fixedly connected to the fixing part, and another end of the driving arm is fixedly connected to the connecting shaft; an end of the connecting shaft away from the driving arm is fixedly connected to the reflecting part.

18. The optical device of claim 17, wherein the at least two supporting parts comprises a first connecting shaft extending along a first direction and a second connecting shaft extending along a second direction, the first direction intersects with the second direction.

19. The optical device of claim 10, wherein the reflecting part is driven to swing/rotate relative to the fixing part by an electrostatic driving method, an electromagnetic driving method, a piezoelectric driving method, or a thermoelectric driving method.
